(19) United States
(12) Patent Application Publication
(10) Pub. No.: US 2026/0183724 A1
(43) Pub. Date: Jul. 2, 2026

(54) METHOD, DEVICE, AND SYSTEM FOR FORMULATING SEMICONDUCTOR MATERIAL

(71) Applicant: SAMSUNG ELECTRONICS CO., LTD., Suwon-si (KR)

(72) Inventors: Won Je CHOI, Suwon-si (KR); JEONGHUN KIM, Suwon-si (KR); JUN-SUK KWAK, Suwon-si (KR); YOUNGCHUN KWON, Suwon-si (KR); EUNSUK KWON, Suwon-si (KR); GAHEE KIM, Suwon-si (KR); Kyungoh KIM, Suwon-si (KR); JOONHYUNG LEE, Suwon-si (KR); BYUNG-KWON CHOI, Suwon-si (KR); TAESIN HA, Suwon-si (KR); DAEWOONG HAN, Suwon-si (KR)

(73) Assignee: SAMSUNG ELECTRONICS CO., LTD., Suwon-si (KR)

(21) Appl. No.: 19/249,346

(22) Filed: Jun. 25, 2025

(30) Foreign Application Priority Data
Dec. 26, 2024 (KR) 10-2024-0196984

(51) Int. Cl. B01F 21/00; B01F 23/80; B01F 35/21; B01F 35/213; B01F 35/22; B01F 101/23; B01F 101/58; G01N 21/51

(52) U.S. Cl. CPC B01F 21/30; B01F 21/02; B01F 23/808; B01F 35/213; B01F 35/2132; B01F 35/2209; G01N 21/51; B01F 2101/23; B01F 2101/58

(57) ABSTRACT

A system for formulating a semiconductor material includes a dispenser configured to dispense a target sample for the semiconductor material into a vial tray based on a formulation ratio, an agitator configured to perform a dissolution of the target sample, a solubility measurement device configured to determine whether the target sample is dissolved, and a controller configured to obtain a solubility of the target sample from the solubility measurement device and control the agitator based on the solubility.

### CROSS-REFERENCE TO RELATED APPLICATION

This application is based on and claims priority to Korean Patent Application No. 10-2024-0196984, filed on Dec. 26, 2024, in the Korean Intellectual Property Office, the disclosure of which is incorporated by reference herein in its entirety.

### BACKGROUND

### 1. Field

The disclosure relates to a method, device, and system for formulating a semiconductor material.

### 2. Description of Related Art

Material formulation may play an important role in material development. Material formulation may refer to mixing a plurality of materials in an appropriate ratio. Material development may aim to find the optimal formulation ratio by evaluating the performance of a final product through formulation of various materials.

Recently, various automated devices for material formulation are being distributed. Typical formulation devices may dispense a target sample and also automatically perform a variety of functions, such as a homogenizing operation such as agitating, an environmental sensing function, and a reagent characterization function. Depending on the applied field of the material, the functions to be performed by automated formulation devices may vary, and it may be important to determine which function to add to the automated formulation devices depending on the field.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments of the disclosure.

According to an aspect of the disclosure, a system for formulating a semiconductor material may include a dispenser configured to dispense a target sample for the semiconductor material into a vial tray based on a formulation ratio, an agitator configured to perform a dissolution of the target sample, a solubility measurement device configured to determine whether the target sample is dissolved, and a controller configured to obtain a solubility of the target sample from the solubility measurement device and control the agitator based on the solubility.

The controller may be further configured to determine whether to additionally perform the dissolution of the target sample with the agitator based on a comparison of the solubility with a preset threshold value.

The controller may be further configured to, based on the solubility being less than the preset threshold value, output a first control signal to the agitator to cause the agitator to perform the dissolution of the target sample until the solubility reaches the preset threshold value.

The system may include a potential of Hydrogen (pH) adjuster configured to adjust a pH of the target sample.

The controller may be further configured to obtain the pH of the target sample from the pH adjuster, and control the pH adjuster based on a comparison of the pH of the target sample with a preset target value.

The controller may be further configured to, based on the pH of the target sample being less than the preset target value, output a second control signal to the pH adjuster to cause the pH adjuster to increase the pH of the target sample, and based on the pH of the target sample being greater than the preset target value, output a third control signal to the pH adjuster to cause the pH adjuster to decrease the pH of the target sample.

The pH adjuster may be configured to increase the pH of the target sample by adding a basic titrant to the target sample based on the second control signal, and decrease the pH of the target sample by adding an acidic titrant to the target sample based on the third control signal.

The system may include a filter configured to filter out impurities included in the target sample.

The system may include a chamber including the dispenser, the agitator, the solubility measurement device, the pH adjuster, and the filter, where an inside of the chamber is filled with a noble gas.

The system may include a transfer device configured to transfer the vial tray on which the target sample is dispensed to one or more of the dispenser, the agitator, the solubility measurement device, the pH adjuster, and the filter based on a formulation process.

According to an aspect of the disclosure, a method of operating an electronic device may include obtaining a solubility of a target sample for a semiconductor material from a solubility measurement device, and controlling an agitator to perform a dissolution of the target sample based on the solubility.

The controlling of the agitator may include determining whether to additionally perform the dissolution of the target sample with the agitator based on a comparison of the solubility with a preset threshold value.

The determining of whether to additionally perform the dissolution of the target sample with the agitator may include, based on the solubility being less than the preset threshold value, outputting a first control signal to the agitator to cause the agitator to perform the dissolution of the target sample until the solubility reaches the preset threshold value.

The method may include obtaining a pH of the target sample from a pH adjuster configured to adjust the pH of the target sample and controlling the pH adjuster based on a comparison of the pH of the target sample with a preset target value.

The controlling of the pH adjuster may include, based on the pH of the target sample being less than the preset target value, outputting a second control signal to the pH adjuster to cause the pH adjuster to increase the pH of the target sample, and based on the pH of the target sample being greater than the preset target value, outputting a third control signal to the pH adjuster to cause the pH adjuster to decrease the pH of the target sample.

According to an aspect of the disclosure, an electronic device may include a processor, and a memory configured to store instructions, where the instructions, when executed individually or collectively by the processor, may cause the electronic device to obtain a solubility of a target sample for a semiconductor material from a solubility measurement device, and control an agitator configured to perform a dissolution of the target sample based on the solubility.

The instructions, when executed individually or collectively by the processor, may further cause the electronic device to determine whether to additionally perform the dissolution of the target sample with the agitator based on a comparison of the solubility with a preset threshold value.

The instructions, when executed individually or collectively by the processor, may further cause the electronic device to, based on the solubility being less than the preset threshold value, output a first control signal to the agitator to cause the agitator to perform the dissolution of the target sample until the solubility reaches the preset threshold value.

The instructions, when executed individually or collectively by the processor, may further cause the electronic device to obtain a pH of the target sample from a pH adjuster configured to adjust the pH of the target sample, and control the pH adjuster based on a comparison of the pH of the target sample with a preset target value.

The instructions, when executed individually or collectively by the processor, may further cause the electronic device to, based on the pH of the target sample being less than the preset target value, output a second control signal to the pH adjuster to cause the pH adjuster to increase the pH of the target sample, and based on the pH of the target sample being greater than the preset target value, output a third control signal to the pH adjuster to cause the pH adjuster to decrease the pH of the target sample.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an example of a development system of a semiconductor material according to one or more embodiments;

FIG. 2 is a diagram illustrating an example of a formulation system according to one or more embodiments;

FIG. 3 is a flowchart illustrating a formulation process performed within a formulation system according to one or more embodiments;

FIG. 4 is a flowchart of a method of formulating a semiconductor material according to one or more embodiments;

FIG. 5 is a flowchart illustrating a process of formulating a semiconductor material controlled by a controller according to one or more embodiments;

FIG. 6 is a diagram illustrating a chamber including devices included in a formulation system according to one or more embodiments; and

FIG. 7 is a diagram illustrating an example of an electronic device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

Hereinafter, example embodiments will be described in detail with reference to the accompanying drawings. The embodiments described below are merely exemplary, and various modifications are possible from these embodiments. In the following drawings, the same reference numerals refer to the same components, and the size of each component in the drawings may be exaggerated for clarity and convenience of description.

In the following description, when a component is referred to as being “above” or “on” another component, it may be directly on an upper, lower, left, or right side of the other component while making contact with the other component or may be above an upper, lower, left, or right side of the other component without making contact with the other component.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

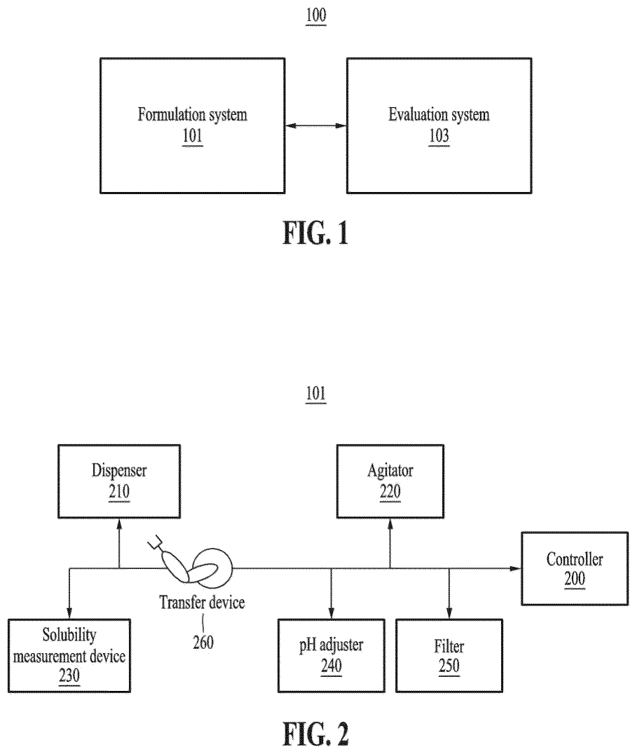

FIG. 1 is a diagram illustrating an example of a development system of a semiconductor material according to one or more embodiments.

Referring to FIG. 1, according to one or more embodiments, a system 100 for developing a semiconductor material may include a formulation system 101 and/or an evaluation system 103. The system 100 may support efficient material development by automating material formulation and/or performance evaluation of formulated materials. For example, the system 100 may reduce development time, minimize repetitive experiments, and support production of highly reliable materials through organic linkage between the formulation system 101 and the evaluation system 103.

According to one or more embodiments, the formulation system 101 is responsible for a mixing process of semiconductor materials and may provide a function of deriving an optimal formulation ratio by combining various materials. In the formulation system 101, a precise process may be performed to automatically formulate various combinations suitable for the properties and purpose of materials and secure homogeneity and quality of the materials. In the formulation system 101, in addition to the process of simply formulating the materials, various processes may be integrated to detect problems that may occur during the formulation and improve them. In the formulation system 101, data is collected and analyzed in real time during the formulation process, thereby providing data for efficient process control and future formulation improvement. The processes performed in the formulation system 101 for formulating semiconductor materials will be described in detail with reference to FIG. 2.

According to one or more embodiments, a material formulated through the formulation system 101 may be transmitted to the evaluation system 103, so that a performance evaluation of the formulated materials may be performed in the evaluation system 103.

According to one or more embodiments, the evaluation system 103 may verify the performance of a material formulated in the formulation system 101 and provide data for improvement. The evaluation system 103 may verify whether the formulated material satisfies physical, electrical, and/or chemical properties required in a semiconductor process. The evaluation system 103 may analyze the performance and stability of the material from various angles, and determine the suitability of the material based on experimental results. The evaluation system 103 may be an integrated platform including data analysis and process feedback functions, which is linked to the formulation system 101 to exchange data in real time and contribute to the material improvement. In particular, in a semiconductor material development environment that requires high precision and repeatability, the evaluation system 103 may play an important role in optimizing the properties of the material and increasing a development speed.

Hereinafter, the formulation system 101 will be described in detail with reference to FIGS. 2 to 7.

FIG. 2 is a diagram illustrating an example of a formulation system according to one or more embodiments.

Referring to FIG. 2, according to one or more embodiments, the formulation system 101 may include a controller 200, a dispenser 210, an agitator 220, a solubility measurement device 230, a potential of Hydrogen (pH) adjuster 240, a filter 250, and/or a transfer device 260. However, embodiments are not limited thereto. For example, the formulation system 101 may also be configured with the controller 200, the dispenser 210, the agitator 220, and the solubility measurement device 230. In another example, the formulation system 101 may further include devices that provide other functions in addition to the above devices.

According to one or more embodiments, the controller 200 may control the dispenser 210, the agitator 220, the solubility measurement device 230, the pH adjuster 240, the filter 250, and/or the transfer device 260 using a network. For example, the network may include a local area network (LAN), a wide area network (WAN), a value added network (VAN), a mobile radio communication network, a satellite communication network, and combinations thereof. The network is a comprehensive data communication network that allows the controller 200, the dispenser 210, the agitator 220, the solubility measurement device 230, the pH adjuster 240, and/or the filter 250 to communicate with each other smoothly, and may include wired Internet, wireless Internet, and mobile wireless communication networks. Also, the wireless communication networks may include, but are not limited to, wireless LAN (wireless fidelity (Wi-Fi)), Bluetooth, Bluetooth low energy, Zigbee, Wi-Fi Direct (WFD), ultra-wideband (UWB), infrared communication (infrared data association (IrDA)), a near field communication (NFC), or the like.

According to one or more embodiments, the controller 200 may transmit a control signal to control the dispenser 210, the agitator 220, the solubility measurement device 230, the pH adjuster 240, the filter 250, and/or the transfer device 260 to each device. The dispenser 210, the agitator 220, the solubility measurement device 230, the pH adjuster 240, the filter 250, and/or the transfer device 260 may perform operations requested by the controller 200 based on the control signal received from the controller 200. For example, the controller 200 may control the transfer device 260 to transfer a vial tray containing a target sample (e.g., a sample to be formulated) to a device corresponding to each order according to the formulation process (e.g., the order of the formulation process).

According to one or more embodiments, the dispenser 210 may dispense a target sample for a semiconductor material into a vial tray according to a formulation ratio. The dispenser 210 may divide the target sample into portions according to the formulation ratio.

According to one or more embodiments, the target sample may be one of a solid sample and a liquid sample. The liquid sample may be, for example, in various forms, such as a liquid, paste, sludge, and viscous oil. The solid sample may be, for example, in various forms, such as powders, granules, pellets, films, and/or fibers.

According to one or more embodiments, when the target sample is a liquid sample, the vial tray may have various shapes that may store the liquid sample without spilling. When the target sample is a liquid sample, the vial tray may include, for example, a transparent flask or a cuvette. When the target sample is a solid sample, the vial tray may be a flat vial tray in which the solid sample may be placed. When the target sample is a solid sample, the vial tray may include, for example, a plate or a slide.

According to one or more embodiments, the dispenser 210 may be implemented as a liquid dispenser, such as a syringe pump and/or pipetting when the target sample is a liquid. The dispenser 210 may be implemented as a powder dispenser when the target sample is a solid. When the target sample contains both liquid and solid samples, the dispenser 210 may include a liquid dispenser and a powder dispenser.

According to one or more embodiments, the target sample dispensed (or divided) into the vial tray through the dispenser 210 may be transferred to the agitator 220 through the transfer device 260. When the dispensing of the target sample from the dispenser 210 is completed, the controller 200 may transmit a control signal to the transfer device 260 to transfer the vial tray containing the target sample to the agitator 220. The transfer device 260 may transfer the vial tray containing the target sample to the agitator 220 based on the control signal.

According to one or more embodiments, the agitator 220 may dissolve the target sample (e.g., perform a dissolution on the target sample). The agitator 220 may mix the target sample so that it is homogeneously dissolved. The agitator 220 may include, for example, a shaker (or a mixer), a stirrer, and/or a sonication device. The shaker and/or the mixer may be of a reciprocating and/or circular orbital type. The stirrer may be a device that dissolves a target sample through a propeller and/or magnet.

In the formulation system 101, when only the process performed by the dispenser 210 and/or the agitator 220 is performed, the following problems may arise, particularly in the formulation process of semiconductor materials.

For example, when the target sample is not sufficiently dissolved, problems may arise in the performance evaluation due to homogeneity. For example, when the target sample is not sufficiently dissolved, undissolved particles may remain as impurities and cause defects. Impurities may affect a resolution of patterns in photoresist, or adversely affect the performance of end products, such as substrate homogeneity, reaction speed, and/or surface.

Furthermore, pH may affect a development speed and/or cleaning effectiveness of a photoresist. For example, when the pH of the target sample (e.g., a developer) is too high, over-development may occur, which may reduce the resolution of the pattern and the precision of the process. On the other hand, when the pH of the developer is too low, the development speed may be reduced and under-development, in which an exposed portion is not completely removed, may occur. That is, adjusting the pH of the target sample to a preset target value may be important in the formulation process.

Thus, in order to solve the problems described above, the formulation system 101 may adjust the properties (e.g., solubility, pH, and/or an impurity ratio) of the target sample dissolved by the agitator 220 through the solubility measurement device 230, the pH adjuster 240, and/or the filter 250. For example, in the formulation system 101, the solubility of the target sample dissolved by the agitator 220 may be measured through the solubility measurement device 230, and only when the solubility is higher than a preset threshold value (or a reference value) (e.g., set by the user), a next process (e.g., a process performed by the pH adjuster 240 and/or the filter 250) may be performed. For example, in the formulation system 101, the pH of the target sample may be adjusted, and only when the pH of the target sample is a target value (e.g., set by the user), a next process (e.g., a process performed by the filter 250) may be performed.

According to one or more embodiments, when the dissolution of the target sample in the agitator 220 is completed, the controller 200 may transmit a control signal to the transfer device 260 to transfer the vial tray containing the target sample to the solubility measurement device 230. The transfer device 260 may transfer the vial tray containing the target sample to the solubility measurement device 230 based on the control signal.

According to one or more embodiments, the solubility measurement device 230 may confirm whether the target sample is dissolved through the agitator 220. The solubility measurement device 230 may measure the solubility of the target sample. The solubility measurement device 230 may transmit the measured solubility to the controller 200.

According to one or more embodiments, the controller 200 may control the agitator 220 based on the solubility. When the solubility is less than a preset threshold value, the controller 200 may determine that additional dissolution of the target sample is required through the agitator 220. The controller 200 may output a first control signal to the agitator 220 to cause the agitator 220 to perform the dissolution of the target sample until the solubility reaches the preset threshold value. The agitator 220 may dissolve the target sample until the solubility of the target sample reaches the preset threshold value based on the first control signal. When the dissolution of the target sample is completed again by the agitator 220, the controller 200 may re-measure the solubility of the target sample through the solubility measurement device 230. As a result of the re-measurement, when the solubility is still less than the preset threshold value, the controller 200 may re-output the first control signal to the agitator 220 as described above. When the solubility of the target sample is greater than the preset threshold value, the controller 200 may transfer the vial tray containing the target sample to the pH adjuster 240 through the transfer device 260, so that the next process is performed by the pH adjuster 240.

According to one or more embodiments, the pH adjuster 240 may measure and/or adjust the pH of the target sample. The controller 200 may obtain the pH of the target sample measured from the pH adjuster 240. The controller 200 may control the pH adjuster 240 based on a comparison of the pH of the target sample with a preset target value. For example, the controller 200 may determine whether the pH of the target sample is required to be adjusted by comparing the pH of the target sample with the preset target value. When it is determined that the pH of the target sample is required to be adjusted, the controller 200 may cause the pH adjuster 240 to adjust the pH of the target sample so that the pH of the target sample reaches the target value. For example, when the pH of the target sample is less than the preset target value, the controller 200 may output a second control signal to the pH adjuster 240 to increase the pH of the target sample. The pH adjuster 240 may increase the pH of the target sample based on the second control signal. For example, when the pH of the target sample is greater than the preset target value, the controller 200 may output a third control signal to the pH adjuster 240 to decrease the pH of the target sample. The pH adjuster 240 may decrease the pH of the target sample based on the third control signal.

According to one or more embodiments, when the solubility and/or the pH of the target sample passes a reference value (e.g., the preset threshold value for the solubility and/or the target value for the pH), the controller 200 may transfer the vial tray containing the target sample to the filter 250 through the transfer device 260 so that the next process is performed by the filter 250.

When the impurities are not removed, evaluations for spin coating performance and/or cleaning performance may be adversely affected. For example, the impurities may interfere with uniform coating in the photoresist, cause pattern damage during an etching process or the like, and cause significant errors in evaluation values during other performance evaluation processes. Accordingly, the removal of the impurities may be very important in the semiconductor process.

According to one or more embodiments, the filter 250 may filter out the impurities contained in the target sample so that the impurities are not mixed into the target sample. The filter 250 may be implemented as a membrane filter such as a syringe filter.

According to one or more embodiments, the transfer device 260 may be implemented as a robot such as a mobile robot and/or an overhead transport (OHT). The vial tray containing the target sample may be transferred to each device (e.g., the dispenser 210, the agitator 220, the solubility measurement device 230, the pH adjuster 240, and/or the filter 250) during a formulation process (e.g., according to the order of the formulation process) by the transfer device 260. The transfer device 260 may be controlled by the controller 200, and the controller 200 may control the transfer device 260 according to the order of the formulation process.

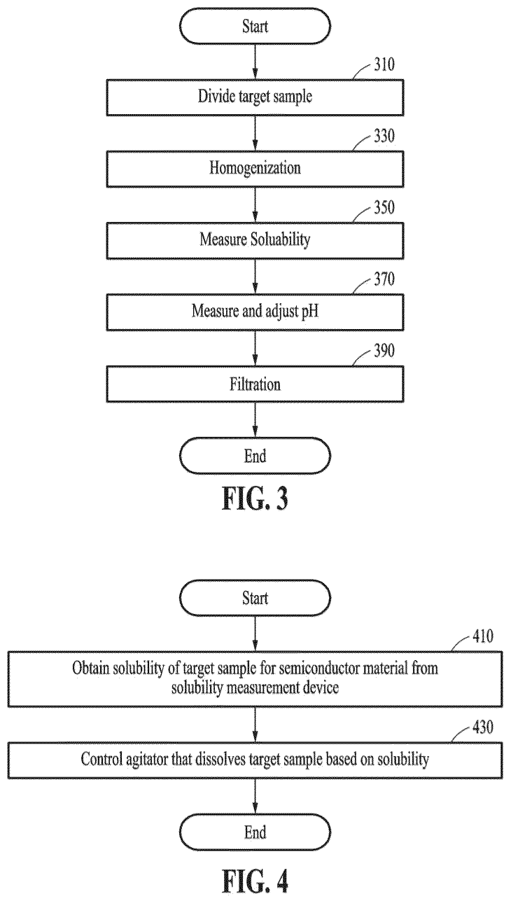

FIG. 3 is a flowchart illustrating a formulation process performed within a formulation system according to one or more embodiments.

Referring to FIG. 3, according to one or more embodiments, operations 310 to 390 may be performed sequentially, but not be necessarily performed sequentially. For example, the order of operations 310 to 390 may be changed, and at least two of operations 310 to 390 may be performed in parallel.

According to one or more embodiments, a controller (e.g., the controller 200 of FIG. 2) may control various devices (e.g., the dispenser 210, the agitator 220, the solubility measurement device 230, the pH adjuster 240, the filter 250, and/or the transfer device 260 of FIG. 2) to cause each of the devices to perform operations 310 to 390. When each operation is completed, the controller 200 may transfer the vial tray containing the target sample to a device to perform the next operation through the transfer device 260. Hereinafter, operations for each device will be described in detail.

In operation 310, a dispenser (e.g., the dispenser 210 of FIG. 2) may dispense (or divide) a target sample into a vial tray according to a formulation ratio. The dispenser 210 may be implemented as a liquid dispenser when the target sample is a liquid. The dispenser 210 may be implemented as a powder dispenser when the target sample is a solid. When the target sample contains both liquid and solid, the dispenser 210 may also be implemented as a device including a liquid dispenser and a powder dispenser.

In operation 330, an agitator (e.g., the agitator 220 of FIG. 2) may homogenize the divided target sample. The agitator 220 may homogeneously dissolve the target sample. The agitator 220 may be implemented as a shaker, a mixer, a stirrer, and/or a sonication device.

In operation 350, a solubility measurement device (e.g., the solubility measurement device 230 of FIG. 2) may measure the solubility of the target sample. The solubility measurement device 230 may measure the solubility by a measurement method using light scattering (e.g., a method of measuring optical density using a spectrophotometer and/or a method of measuring solubility using a nephelometry (and/or a turbidimeter)), a measurement method using machine learning, and/or a measurement method using image analysis. However, the method of measuring the solubility is not limited to the above examples, and various methods may also be used.

In operation 370, a pH adjuster (e.g., the pH adjuster 240 of FIG. 2) may measure and adjust the pH of the target sample. The pH adjuster 240 may measure the pH of the target sample using a pH meter. The pH adjuster 240 may control the amount of titrant added to adjust the pH of the target sample. For example, when the pH of the target sample is less than a preset target value, the controller 200 may output a second control signal to the pH adjuster 240 to increase the pH of the target sample. The pH adjuster 240 may increase the pH of the target sample by adding a basic titrant to the vial tray containing the target sample based on the second control signal. For example, when the pH of the target sample is greater than the preset target value, the controller 200 may output a third control signal to the pH adjuster 240 to decrease the pH of the target sample. The pH adjuster 240 may decrease the pH of the target sample by adding an acidic titrant to the vial tray containing the target sample based on the third control signal. The pH adjustment method has been described above based on the method of adding the titrant, however, the pH adjustment method is not limited thereto. The pH of the target sample may be adjusted by various methods, such as electrochemical methods (e.g., electrolysis and/or electrodialysis).

In operation 390, a filter (e.g., the filter 250 of FIG. 2) may filter the impurities included in the target sample, and the filter 250 may be implemented as, for example, a membrane filter, such as a syringe filter. However, the implementation example of the filter 250 is not limited thereto.

FIG. 4 is a flowchart of a method of formulating a semiconductor material according to one or more embodiments.

Referring to FIG. 4, according to one or more embodiments, operations 410 and 430 may be performed sequentially, but not be necessarily performed sequentially. For example, the order of operations 410 through 430 may be changed, and at least two of operations 410 through 430 may be performed in parallel.

In operation 410, a controller (e.g., the controller 200 of FIG. 2) may obtain the solubility of a target sample of a semiconductor material from a solubility measurement device (e.g., the solubility measurement device 230 of FIG. 2).

In operation 430, the controller 200 may control an agitator (e.g., the agitator 220 of FIG. 2) that dissolves the target sample based on the solubility. The controller 200 may determine whether to additionally perform the dissolution of the target sample through the agitator 220 based on a comparison of the solubility with a preset threshold value (e.g., set by the user). When the solubility is less than a preset threshold value, the controller 200 may determine that additional dissolution of the target sample is required through the agitator 220. When the solubility of the target sample is less than the preset threshold value, the controller 200 may output a first control signal to the agitator 220 to cause the agitator 220 to perform the dissolution of the target sample until the solubility reaches the preset threshold value.

According to one or more embodiments, the controller 200 may adjust the pH of the target sample when the solubility of the target sample is higher than the preset threshold value. The controller 200 may obtain the pH of the target sample from a pH adjuster (e.g., the pH adjuster 240 of FIG. 2). The controller 200 may control the pH adjuster 240 by comparing the pH of the target sample with a preset target value (e.g., set by the user). For example, when the pH of the target sample is less than the preset target value, the controller 200 may output a second control signal to the pH adjuster 240 to increase the pH of the target sample. The pH adjuster 240 may increase the pH of the target sample based on the second control signal by the same method as the method of adding the basic titrant. For example, when the pH of the target sample is greater than the preset target value, the controller 200 may output a third control signal to the pH adjuster 240 to decrease the pH of the target sample. The pH adjuster 240 may decrease the pH of the target sample based on the third control signal by the same method as the method of adding the acidic titrant.

According to one or more embodiments, when the solubility and the pH of the target sample are adjusted, the controller 200 may remove impurities in the target sample through a filter (e.g., the filter 250 of FIG. 2).

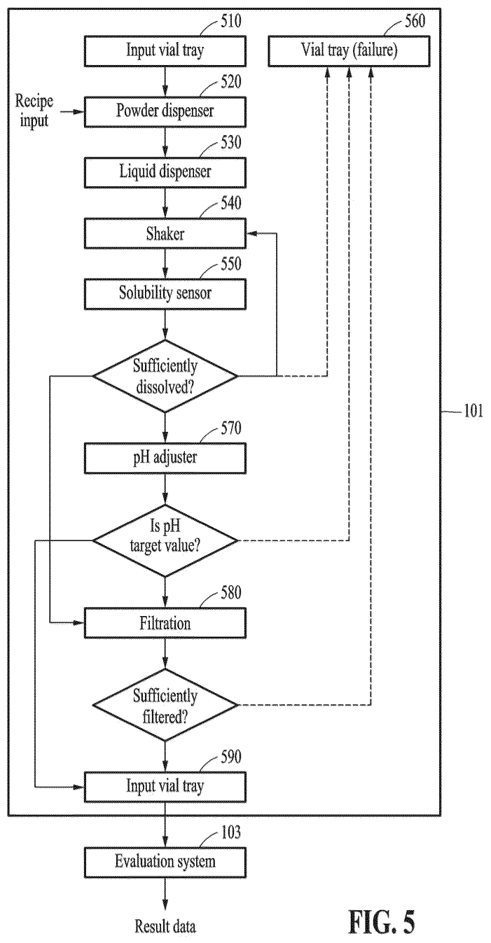

FIG. 5 is a flowchart illustrating a process of formulating a semiconductor material controlled by a controller according to one or more embodiments.

Referring to FIG. 5, according to one or more embodiments, a controller (e.g., the controller 200 of FIG. 2) may control the process of formulating the semiconductor material.

According to one or more embodiments, the controller 200 may transfer an input vial tray 510 containing a target sample to a dispenser (e.g., the dispenser 210 of FIG. 2) (e.g., a powder dispenser 520 and/or a liquid dispenser 530) through a transfer device (e.g., the transfer device 260 of FIG. 2). The target sample may be a solid and/or a liquid, and thus, a case in which the target sample includes both the solid and liquid will be described hereinafter.

According to one or more embodiments, the controller 200 may obtain a formulation ratio of the target sample based on a recipe input. The controller 200 may control the powder dispenser 520 to dispense (or divide) a solid sample into the input vial tray 510 according to the formulation ratio of the target sample.

According to one or more embodiments, when the solid sample is dispensed into the input vial tray 510 by the powder dispenser 520, the controller 200 may control the liquid dispenser 530 to dispense (or divide) a liquid sample into the input vial tray 510 according to the formulation ratio of the target sample.

According to one or more embodiments, when the target sample is dispensed into the input vial tray 510 according to the formulation ratio by the dispenser (e.g., the powder dispenser 520 and/or the liquid dispenser 530), the controller 200 may cause the transfer device 260 to transfer the input vial tray 510 to an agitator 540 (e.g., the agitator 220 of FIG. 2). The agitator 540 may dissolve the target sample contained in the input vial tray 510.

According to one or more embodiments, when the dissolution of the target sample is completed by the agitator 540, the controller 200 may cause the transfer device 260 to transfer the input vial tray 510 to a solubility sensor 550 (e.g., the solubility measurement device 230 of FIG. 2). The solubility sensor 550 may measure the solubility of the target sample and transmit the measured solubility to the controller 200. The controller 200 may confirm whether the target sample is sufficiently dissolved by comparing the solubility with a preset threshold value. When the solubility of the target sample is greater than the preset threshold value, the controller 200 may measure and/or adjust the pH of the target sample by a pH adjuster (e.g., the pH adjuster 240 of FIG. 2). When the solubility of the target sample is less than the preset threshold value, the controller 200 may additionally perform the dissolution of the target sample through the agitator 540. When the dissolution of the target sample is additionally performed by the agitator 540, the solubility may be re-measured through the solubility sensor 550. As a result of the re-measurement, when the solubility is greater than the preset threshold value, the target sample may be processed by the pH adjuster 240. However, as a result of the re-measurement, when the solubility is still less than the preset threshold value, the controller 200 may additionally perform the dissolution of the target sample through the agitator 540, however, may also classify the input vial tray 510 as a failure vial tray 560 to terminate the formulation process.

According to one or more embodiments, when the target sample is sufficiently dissolved (e.g., when the solubility of the target sample is greater than the preset threshold value), the controller 200 may cause the transfer device 260 to transfer the input vial tray 510 to a pH adjuster 570. The pH adjuster 570 may measure and/or adjust the pH of the target sample contained in the input vial tray 510. The controller 200 may determine whether it is necessary to adjust the pH of the target sample by comparing the pH of the target sample measured by the pH adjuster 570 with the target value. For example, when the pH of the target sample is the target value (or when the pH of the target sample is within a predetermined range of the target value), the controller 200 may determine that it is not necessary to adjust the pH of the target sample. In this case, the impurities in the target sample may be removed through a filter 580 (e.g., the filter 250 of FIG. 2). However, when the pH of the target sample is different from the target value (e.g., when the pH of the target sample is not within the predetermined range of the target value), the controller 200 may adjust the pH of the target sample through the pH adjuster 570.

According to one or more embodiments, the pH adjuster 570 may adjust the pH of the target sample and re-measure the adjusted pH. As a result of the re-measurement, when the pH of the target sample is the target value, the target sample may be processed by the filter 580. However, as a result of the re-measurement, when the pH of the target sample is significantly different from the target value, the controller 200 may additionally adjust the pH of the target sample through the pH adjuster 570, but may also classify the input vial tray 510 as the failure vial tray 560 to terminate the formulation process.

According to one or more embodiments, when the pH of the target sample is the target value (e.g., when the pH of the target sample is within the predetermined range of the target value), the controller 200 may cause the transfer device 260 to transfer the input vial tray 510 to the filter 580. The filter 580 may filter out the impurities in the target sample contained in the input vial tray 510. The controller 200 may determine whether the impurities are sufficiently filtered out. When the impurities are sufficiently filtered out, the controller 200 may set the input vial tray 510 as an output vial tray 590 and output the output vial tray 590 to the evaluation system 103. When the impurities are not sufficiently filtered out, the controller 200 may re-filter the impurities in the target sample through the filter 580, but may also classify the input vial tray 510 as the failure vial tray 560 to terminate the formulation process.

According to one or more embodiments, in the evaluation system 103, a performance evaluation of the formulation result (e.g., the target sample contained in the output vial tray 590) may be performed, and a performance evaluation result (e.g., result data) may be provided to a user.

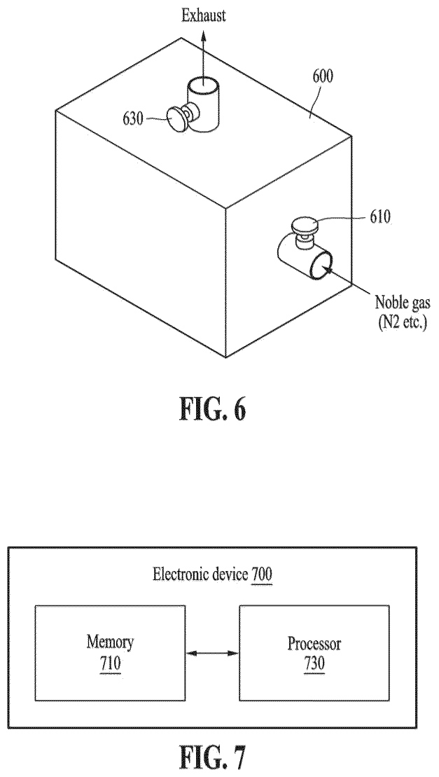

FIG. 6 is a diagram illustrating a chamber including devices included in a formulation system according to one or more embodiments.

Referring to FIG. 6, according to one or more embodiments, a formulation system (e.g., the formulation system 101 of FIG. 1) may be implemented inside a chamber 600. For example, the dispenser 210, the agitator 220, the solubility measurement device 230, the pH adjuster 240, and/or the filter 250 of FIG. 2 may be included in the chamber 600.

According to one or more embodiments, the chamber 600 may be filled with a noble gas. For example, the noble gas (e.g., nitrogen) may be introduced into the chamber 600 through a separate device. The noble gas may be introduced into the chamber 600 through a valve 610 provided on an inlet, and exhausted through a valve 630 provided on an outlet.

According to one or more embodiments, in a case where the formulation system 101 is implemented in the chamber 600 filled with the noble gas, even when a material vulnerable to oxygen or moisture is used, the formulation process may be safely performed by a noble gas atmosphere with almost no oxygen or moisture.

FIG. 7 is a diagram illustrating an example of an electronic device according to one or more embodiments.

Referring to FIG. 7, according to one or more embodiments, an electronic device 700 may include a memory 710 and a processor 730. The description provided with reference to FIGS. 1 to 6 may also apply to FIG. 7. For example, the controller 200 of FIG. 2 may be the electronic device 700.

The memory 710 may store instructions (or programs) executable by the processor 730. For example, the instructions may include instructions to perform an operation of the processor 730 and/or an operation of each component of the processor 730.

The memory 710 may be implemented as a volatile memory device or a non-volatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 730 may process data stored in the memory 710. The processor 730 may execute computer-readable code (e.g., software) stored in the memory 710 and instructions triggered by the processor 730.

The processor 730 may be a hardware-implemented data processing device having a circuit that is physically structured to execute desired operations. The desired operations may include, for example, code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 730 may cause the electronic device 700 to perform one or more operations by executing the code and/or instructions stored in the memory 710. The operations performed by the electronic device 700 may be substantially the same as the operations performed by the controller 200 described with reference to FIGS. 1 to 6. Accordingly, a repeated description thereof is omitted.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc (CD)-ROM discs, digital video discs (DVDs), and/or Blue-ray discs; magneto-optical media such as optical discs; and hardware devices that are specially configured to store and perform program instructions, such as read-only memory (ROM), random access memory (RAM), flash memory (e.g., universal serial bus (USB) flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A system for formulating a semiconductor material, the system comprising:
a dispenser configured to dispense a target sample for the semiconductor material into a vial tray based on a formulation ratio;
an agitator configured to perform a dissolution of the target sample;
a solubility measurement device configured to determine whether the target sample is dissolved; and
a controller configured to obtain a solubility of the target sample from the solubility measurement device and control the agitator based on the solubility.

2. The system of claim 1, wherein the controller is further configured to determine whether to additionally perform the dissolution of the target sample with the agitator based on a comparison of the solubility with a preset threshold value.

3. The system of claim 2, wherein the controller is further configured to, based on the solubility being less than the preset threshold value, output a first control signal to the agitator to cause the agitator to perform the dissolution of the target sample until the solubility reaches the preset threshold value.

4. The system of claim 1, further comprising:
a potential of Hydrogen (pH) adjuster configured to adjust a pH of the target sample.

5. The system of claim 4, wherein the controller is further configured to:
obtain the pH of the target sample from the pH adjuster; and
control the pH adjuster based on a comparison of the pH of the target sample with a preset target value.

6. The system of claim 5, wherein the controller is further configured to:
based on the pH of the target sample being less than the preset target value, output a second control signal to the pH adjuster to cause the pH adjuster to increase the pH of the target sample; and
based on the pH of the target sample being greater than the preset target value, output a third control signal to the pH adjuster to cause the pH adjuster to decrease the pH of the target sample.

7. The system of claim 6, wherein the pH adjuster is configured to:
increase the pH of the target sample by adding a basic titrant to the target sample based on the second control signal; and
decrease the pH of the target sample by adding an acidic titrant to the target sample based on the third control signal.

8. The system of claim 4, further comprising:
a filter configured to filter out impurities included in the target sample.

9. The system of claim 8, further comprising:
a chamber comprising the dispenser, the agitator, the solubility measurement device, the pH adjuster, and the filter,
wherein an inside of the chamber is filled with a noble gas.

10. The system of claim 8, further comprising:
a transfer device configured to transfer the vial tray on which the target sample is dispensed to one or more of the dispenser, the agitator, the solubility measurement device, the pH adjuster, and the filter based on a formulation process.

11. A method of operating an electronic device, the method comprising:
obtaining a solubility of a target sample for a semiconductor material from a solubility measurement device; and
controlling an agitator to perform a dissolution of the target sample based on the solubility.

12. The method of claim 11, wherein the controlling of the agitator comprises determining whether to additionally perform the dissolution of the target sample with the agitator based on a comparison of the solubility with a preset threshold value.

13. The method of claim 12, wherein the determining of whether to additionally perform the dissolution of the target sample with the agitator comprises, based on the solubility being less than the preset threshold value, outputting a first control signal to the agitator to cause the agitator to perform the dissolution of the target sample until the solubility reaches the preset threshold value.

14. The method of claim 11, further comprising:
obtaining a potential of Hydrogen (pH) of the target sample from a pH adjuster configured to adjust the pH of the target sample; and
controlling the pH adjuster based on a comparison of the pH of the target sample with a preset target value.

15. The method of claim 14, wherein the controlling of the pH adjuster comprises:
based on the pH of the target sample being less than the preset target value, outputting a second control signal to the pH adjuster to cause the pH adjuster to increase the pH of the target sample; and
based on the pH of the target sample being greater than the preset target value, outputting a third control signal to the pH adjuster to cause the pH adjuster to decrease the pH of the target sample.

16. An electronic device comprising:
a processor; and
a memory configured to store instructions,
wherein the instructions, when executed individually or collectively by the processor, cause the electronic device to:
obtain a solubility of a target sample for a semiconductor material from a solubility measurement device; and
control an agitator configured to perform a dissolution of the target sample based on the solubility.

17. The electronic device of claim 16, wherein the instructions, when executed individually or collectively by the processor, further cause the electronic device to:
determine whether to additionally perform the dissolution of the target sample with the agitator based on a comparison of the solubility with a preset threshold value.

18. The electronic device of claim 17, wherein the instructions, when executed individually or collectively by the processor, further cause the electronic device to:
based on the solubility being less than the preset threshold value, output a first control signal to the agitator to cause the agitator to perform the dissolution of the target sample until the solubility reaches the preset threshold value.

19. The electronic device of claim 16, wherein the instructions, when executed individually or collectively by the processor, further cause the electronic device to:
obtain a potential of Hydrogen (pH) of the target sample from a pH adjuster configured to adjust the pH of the target sample; and
control the pH adjuster based on a comparison of the pH of the target sample with a preset target value.

20. The electronic device of claim 19, wherein the instructions, when executed individually or collectively by the processor, further cause the electronic device to:
based on the pH of the target sample being less than the preset target value, output a second control signal to the pH adjuster to cause the pH adjuster to increase the pH of the target sample; and
based on the pH of the target sample being greater than the preset target value, output a third control signal to the pH adjuster to cause the pH adjuster to decrease the pH of the target sample.
